(19) United States
(12) Patent Application Publication
(10) Pub. No.: US 2026/0084162 A1
(43) Pub. Date: Mar. 26, 2026

(54) HANDHELD SPRAY GUN

(71) Applicant: Wenzhou BOYU Technology Co., Ltd., Wenzhou (CN)

(72) Inventor: Lingfang Dai, Wenzhou (CN)

(21) Appl. No.: 19/406,894

(22) Filed: Dec. 2, 2025

Related U.S. Application Data
(63) Continuation-in-part of application No. 18/983,419, filed on Dec. 17, 2024, now Pat. No. 12,508,605.

(30) Foreign Application Priority Data
Oct. 20, 2023 (CN) 202322821236.9
Nov. 13, 2024 (CN) 202430719193.0
Dec. 6, 2024 (CN) 202423003616.2

(51) Int. Cl. B05B 1/30; B05B 9/01; B05B 12/00

(52) U.S. Cl. CPC B05B 1/3013; B05B 9/01; B05B 12/0024

(57) ABSTRACT

A handheld spray gun includes a spray gun body, an adjustment mechanism, and a pressing rod. The spray gun body defines a flow channel. At least a portion of the adjustment mechanism is movably arranged in the flow channel. The adjustment mechanism is configured to block, partially block, or open the flow channel. A first end of the pressing rod is movably connected to the spray gun body, and a second end of the pressing rod is swingable about the first end, enabling the pressing rod to drive at least a portion of the adjustment mechanism to move in the flow channel.

### CROSS REFERENCE TO RELATED APPLICATIONS

This application is a continuation-in-part of the U.S. patent application Ser. No. 18/983,419, filed on Dec. 17, 2024. The U.S. patent application Ser. No. 18/983,419 claims the priorities of the Chinese patent application No. 202322821236.9, filed on Oct. 20, 2023, Chinese patent application No. 202430719193.0, filed on Nov. 13, 2024, and Chinese patent application No. 202423003616.2, filed on Dec. 6, 2024, the disclosure of which are hereby incorporated by reference in their entireties.

### FIELD OF THE DISCLOSURE

The present disclosure relates to the technical field of spray devices, and in particular, to a handheld spray gun.

### BACKGROUND

Handheld water spray guns are widely used in cleaning and gardening operations, often used in application scenarios requiring changes in water flow direction, such as flushing grease, washing vehicles, cleaning floors, and cleaning walls and equipment surfaces.

Existing handheld water spray guns generally only have a single water outlet mode. A single water outlet mode corresponds to a single water usage environment, making it difficult to meet diversified usage requirements. For example, when used in kitchens, there are usage requirements such as cleaning sinks, cleaning floors, and washing vegetables. Different uses have different requirements for water flow rate. Conventional handheld water spray guns have difficulty controlling water flow, which may lead to water waste.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

In some embodiments, a handheld spray gun is provided. The handheld spray gun includes a spray gun body, an adjustment mechanism, and a pressing rod. The spray gun body defines a flow channel. At least a portion of the adjustment mechanism is movably arranged in the flow channel. The adjustment mechanism is configured to block, partially block, or open the flow channel. A first end of the pressing rod is movably connected to the spray gun body, and a second end of the pressing rod is swingable about the first end, enabling the pressing rod to drive at least a portion of the adjustment mechanism to move in the flow channel.

### BRIEF DESCRIPTION OF THE DRAWINGS

Illustrative embodiments of the present disclosure are described in detail below with reference to the attached drawing figures.

FIG. 1 is a first cross-sectional view of a handheld spray gun according to an embodiment of the present disclosure.

FIG. 2 is a second cross-sectional view of the handheld spray gun according to an embodiment of the present disclosure.

FIG. 3 is a structural view of a second adjustment assembly according to an embodiment of the present disclosure.

FIG. 4 is a first schematic view of an overall structure of the handheld spray gun according to an embodiment of the present disclosure, showing a state where a first adjustment assembly blocks a flow channel.

FIG. 5 is a second schematic view of an overall structure of the handheld spray gun according to an embodiment of the present disclosure, showing a state where the first adjustment assembly opens the flow channel, and a first engagement ring is engaged with an engagement protrusion.

FIG. 6 is a schematic view of the overall structure of the handheld spray gun according to another embodiment of the present disclosure, showing a state where the first adjustment assembly opens the flow channel, and a second engagement ring sleeves a recess portion and a grip member.

FIG. 7 is a schematic view of an inlet channel and outlet channels according to an embodiment of the present disclosure.

FIG. 8 is a schematic view of an overall structure of a spray head according to an embodiment of the present disclosure.

FIG. 9 is an exploded view of the spray head according to an embodiment of the present disclosure.

FIG. 10 is a schematic view of an overall structure of a flow dividing assembly according to an embodiment of the present disclosure.

FIG. 11 is a schematic view of a first contact member and a second contact member according to an embodiment of the present disclosure, showing a contact state between the first contact member and the second contact member.

FIG. 12 is a schematic view of the first contact member and the second contact member according to an embodiment of the present disclosure, showing another contact state between the first contact member and the second contact member.

FIG. 13 is a structural view of the first contact member and the second contact member according to an embodiment of the present disclosure.

FIG. 14 is a structural view of the second contact member in which a fourth outlet channel is L-shaped according to an embodiment of the present disclosure.

FIG. 15 is a structural view of the first contact member according to an embodiment of the present disclosure, showing a distribution manner of second inlet channels in the first contact member.

FIG. 16 is a structural view of the first contact member according to an embodiment of the present disclosure, showing another distribution manner of second inlet channels in the first contact member.

FIG. 17 is an exploded view of a mounting member, a second seat, a second contact member, a first seat, and a first contact member according to an embodiment of the present disclosure.

FIG. 18 is a structural view of an outlet member according to an embodiment of the present disclosure.

FIG. 19 is a structural view of various first outlet heads according to an embodiment of the present disclosure.

FIG. 20 is a cross-sectional view of the spray head in a state where the inlet channel is communicated with the first outlet channel according to an embodiment of the present disclosure.

FIG. 21 is a cross-sectional view of a housing according to an embodiment of the present disclosure.

### REFERENCE NUMERALS IN THE DRAWINGS

1a—spray gun body; 10a—flow channel; 11a—flow restricting portion; 110a—flow restricting opening;
2a—adjustment mechanism;
20a—first adjustment assembly;
30a—second adjustment assembly; 31a—blocking member; 32a—center rod; 33a—limiting rod; 311a—first end of the blocking member; 312a—second end of the blocking member; 313a—limiting notch; 3121a—blocking part; 3122a—through channel; 3131a—first abutting end; 3132a—second abutting end;
1000—spray head; 101—first outlet channel; 102—second outlet channel; 103—third outlet channel;
1—housing; 11—mounting cavity; 111—second positioning groove; 121—through hole;
2—flow dividing assembly;
21—second seat; 211—first outlet branch; 212—second outlet branch; 213—receiving groove; 214—first positioning groove; 215—second positioning protrusion;
22—second contact member; 221—third outlet branch; 222—fourth outlet branch; 223—top face; 224—bottom face; 225—side face; 226—first positioning protrusion;
23—outlet member; 231—first outlet head; 2310—first outlet hole; 2311—sleeve; 232—second outlet head; 2320—second outlet hole;
24—mounting member; 241—nest protrusion;
2000—grip member;
301—inlet channel; 3011—first connection channel; 3012—second connection channel; 302—blocking portion; 3021—connection opening; 3023—vertical channel;
4—pressing member; 43—straight rod; 44—plug;
5—connection seat; 51—first seat; 511—first inlet branch; 52—first contact member; 521—second inlet branch;
6—pressing rod; 601—first end of the pressing rod; 602—second end of the pressing rod; 603—recess portion; 61—engagement protrusion; 611—abutting face;
7—reset member;
8—first engagement ring;
9—second engagement ring.

### DETAILED DESCRIPTION

The following describes some non-limiting exemplary embodiments of the disclosure with reference to the accompanying drawings. The described embodiments are merely a part rather than all of the embodiments of the disclosure. All other embodiments obtained by a person of ordinary skill in the art based on the embodiments of the disclosure shall fall within the scope of the disclosure.

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “including” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be included in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

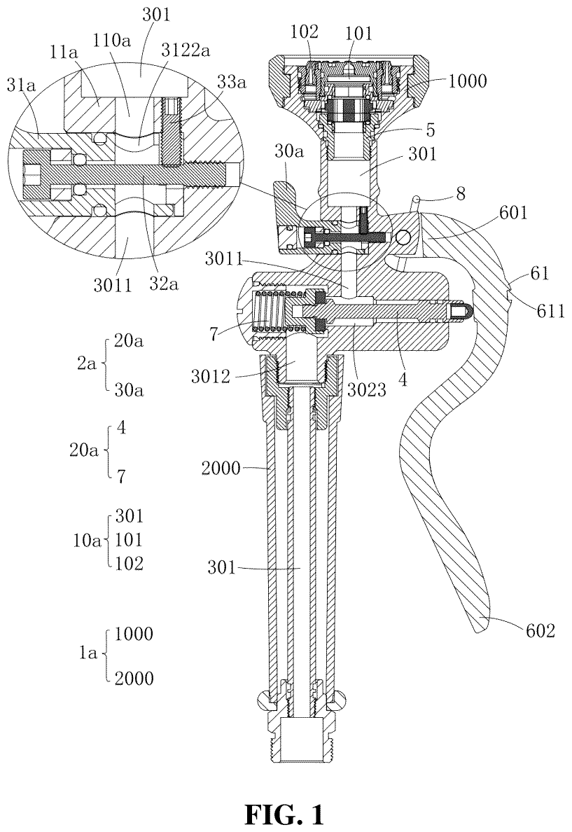

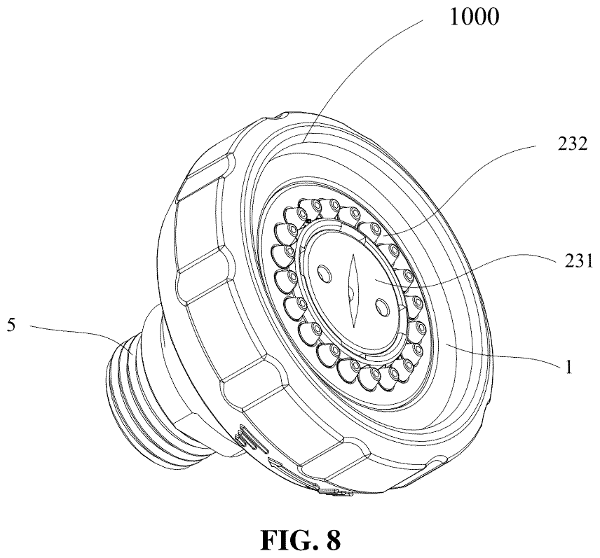

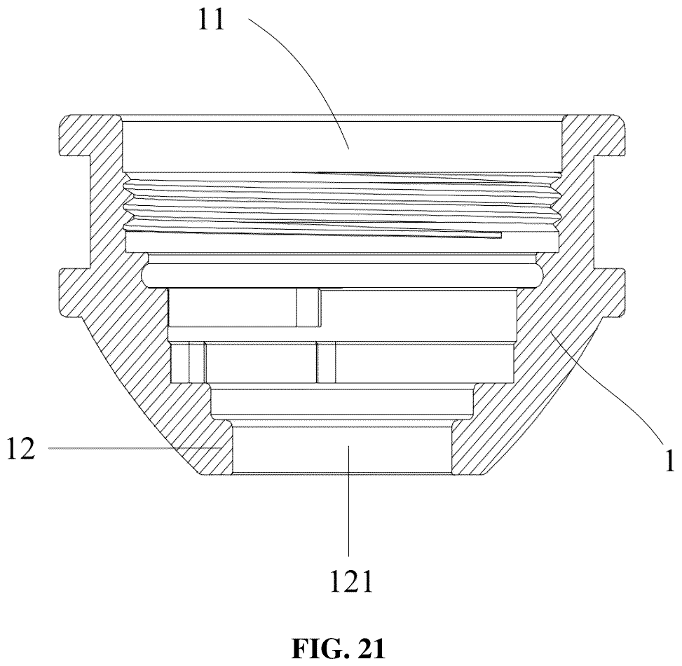

Referring to FIGS. 1 to 21, the present disclosure provides a handheld spray gun. The handheld spray gun may include a spray gun body 1a, an adjustment mechanism 2a, and a pressing rod 6. The spray gun body 1a may define a flow channel 10a and an outlet port. The flow channel 10a may be communicated to an outside of the spray gun body 1a via the outlet port. At least a part of the adjustment mechanism 2a may be movably arranged in the flow channel 10a to block, partially block, or open the flow channel 10a. A first end 601 of the pressing rod 6 may be movably connected to the spray gun body 1a, and a second end 602 of the pressing rod 6 may be swingable about the first end 601, enabling the pressing rod 6 to drive at least a part of the adjustment mechanism 2a to move in the flow channel 10a.

The adjustment mechanism 2a may include a first adjustment assembly 20a and a second adjustment assembly 30a. At least a part of the first adjustment assembly 20a may extend and may be slidably arranged in the flow channel 10a. The pressing rod 6 may be drivingly connected to the first adjustment assembly 20a to block or open the flow channel 10a. That is, the first adjustment assembly 20a may be used to determine whether a flow may flow out from the outlet port. At least a part of the second adjustment assembly 30a may be movably arranged in the flow channel 10a for adjusting a flow rate of the flow channel 10a, that is, for regulating the flow rate of the flow flowing out from the outlet port.

It should be noted that the handheld spray gun may be used to connect water flow or air flow, that is, fluid or gas may flow out from the outlet port.

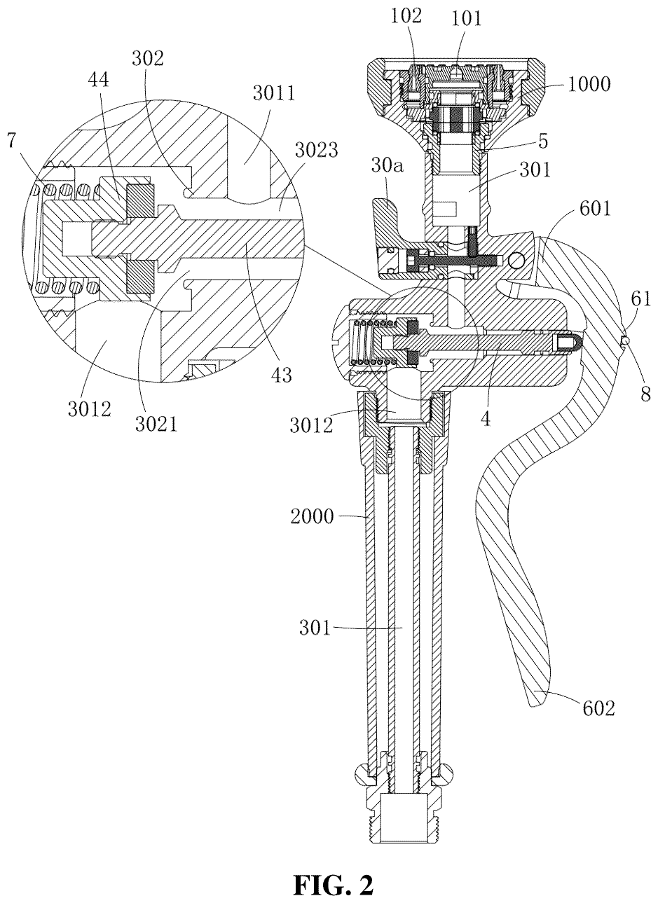

Regarding the first adjustment assembly 20a, in some embodiments, referring to FIGS. 1 and 2, the first adjustment assembly 20a may include a pressing member 4 and a reset member 7. The pressing member 4 may be slidably mounted to the spray gun body 1a and may extend to the flow channel 10a. The pressing member 4 may correspondingly open or block the flow channel 10a when sliding. The reset member 7 may be arranged in the flow channel 10a and connected to the pressing member 4. The reset member 7 may drive the pressing member 4 to slide outward from the spray gun body 1a.

Specifically, one end of the pressing member 4 may extend into the flow channel 10a, and the other end of the pressing member 4 may be exposed outside the spray gun body 1a for user operation. When the user applies an external force to the pressing member 4, the pressing member 4 may be driven to slide, thereby blocking or opening the flow channel 10a. According to a magnitude of the external force applied by the user, a sliding stroke of the pressing member 4 may be controlled, that is, the flow rate may be adjusted. The reset member 7 may be a compression spring, that is, an elastic force direction of the compression spring on the pressing member 4 may be toward the outside of the spray gun body 1a.

Furthermore, a sliding direction of the pressing member 4 may be perpendicular to an extending direction of the flow channel 10a, and the pressing member 4 may be arranged at a position on the spray gun body 1a close to the outlet port, that is, arranged in an area convenient for user's thumb to operate. During use, the user may apply pressure to the pressing member 4 with the thumb while holding the spray gun body 1a with one hand.

During use, the user may press the first adjustment assembly 20a with one hand to open the flow channel 10a, causing the outlet port to discharge the flow to the outside. However, due to a lack of flexibility of a push-button switch, it may be very difficult to control the outflow rate solely by relying on the pressing member 4. Therefore, an additional second adjustment assembly 30a may be arranged to allow users to precisely and flexibly regulate the outflow rate according to the usage scenarios, reducing resource waste.

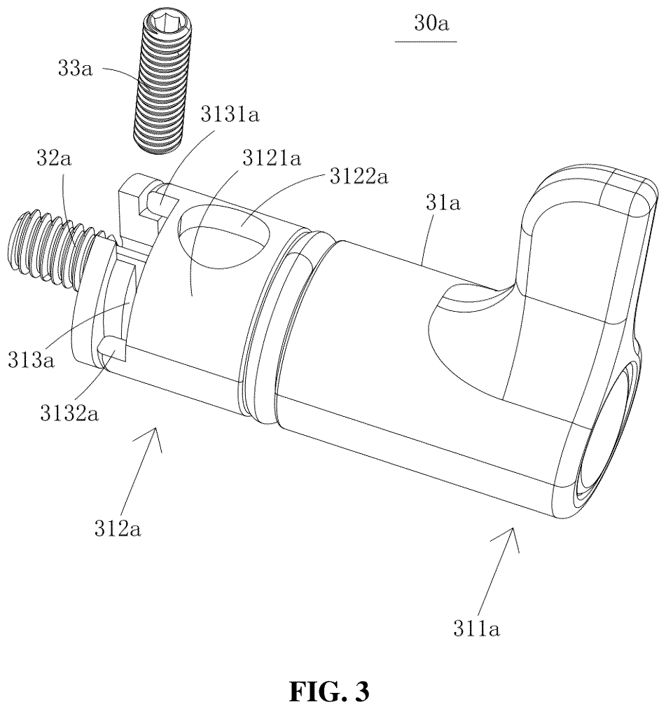

Regarding the second adjustment assembly 30a, in some embodiments, referring to FIGS. 1 and 3, specifically, the spray gun body 1a may be arranged with a flow restricting portion 11a in the flow channel 10a. The flow restricting portion 11a may be arranged in the flow channel 10a and may restrict the flow channel 10a. The flow restricting portion 11a may be arranged with a flow restricting opening 110a, and a section of the flow channel 10a on one side of the flow restricting portion 11a and the other section of the flow channel 10a on the other side of the flow restricting portion 11a may be communicated with each other via the flow restricting opening 110a. The second adjustment assembly 30a may include a blocking member 31a. The blocking member 31a may be movably mounted to the spray gun body 1a. A first end 311a of the blocking member 31a may be arranged outside the spray gun body 1a, and a second end 312a of the blocking member 31a may be located in the flow channel 10a. The user may change a state of the second end 312a by operating the first end 311a of the blocking member 31a. Driving the first end 311a of the blocking member 31a to move may correspondingly cause the second end 312a of the blocking member 31a to partially block or open the flow restricting opening 110a. When the second end 312a of the blocking member 31a partially blocks the flow restricting opening 110a, the flow passing through the flow restricting opening 110a may decrease. The flow rate may be regulated according to a blocking degree of the blocking member 31a controlled by the user. When the second end 312a of the blocking member 31a completely opens the flow restricting opening 110a, the flow passing through the flow restricting opening 110a may be unrestricted by the blocking member 31a.

Regarding a structure of the blocking member 31a, for example, in some embodiments, the blocking member 31a may be rotatably mounted to the spray gun body 1a, and a rotation axis of the blocking member 31a may be perpendicular to an axis of the flow restricting opening 110a. The second end 312a of the blocking member 31a may include a blocking part 3121a. The blocking part 3121a may define a through channel 3122a penetrating through the blocking part 3121a. The through channel 3122a may be communicated with the flow restricting opening 110a, and an axis of the through channel 3122a may be perpendicular to the rotation axis of the blocking member 31a. Rotating the blocking member 31a may cause the through channel 3122a to be communicated with the flow restricting opening 110a to open the flow restricting opening 110a, or cause the blocking part 3121a to partially block the flow restricting opening 110a. That is, rotating the blocking member 31a may adjust a size of a communicated area between the through channel 3122a and the flow restricting opening 110a in an axial direction of the flow restricting opening 110a. The size of the communicated area may be equivalent to an opening degree of the flow channel 10a. By controlling the size of the communicated area, the outflow rate may be controlled.

To prevent excessive rotation angle of the blocking member 31a, a limiting notch 313a may further be formed on the blocking member 31a, as shown in FIG. 3. The limiting notch 313a may be specifically formed at the second end 312a of the blocking member 31a. The blocking member 31a may include a first abutting end 3131a on one side of the limiting notch 313a and a second abutting end 3132a on the other side of the limiting notch 313a. The second adjustment assembly 30a may further include a center rod 32a and a limiting rod 33a. The center rod 32a may penetrate through the blocking member 31a and may be fixed to the spray gun body 1a, so that the blocking member 31a may rotate about the center rod 32a. The limiting rod 33a may be mounted in the flow channel 10a, and the limiting rod 33a may extend to the limiting notch 313a. Rotating the blocking member 31a may cause the limiting rod 33a to abut against the first abutting end 3131a or against the second abutting end 3132a. When the limiting rod 33a abuts against the first abutting end 3131a, the flow restricting opening 110a may be fully opened; when the limiting rod 33a abuts against the second abutting end 3132a, the flow restricting opening 110a may be almost completely blocked. In some examples, when the limiting rod 33a abuts against the second abutting end 3132a, the flow restricting opening 110a may be left with a minimum opening. When the limiting rod 33a is located between the first abutting end 3131a and the second abutting end 3132a, the flow restricting opening 110a may be partially blocked.

Regarding the structure of the blocking member 31a, for example, in other embodiments (not shown in the drawings), the blocking member 31a may be still rotatably mounted to the spray gun body 1a, but a difference from the previous embodiment may be that in this embodiment, the rotation axis of the blocking member 31a may be parallel to the axis of the flow restricting opening 110a and the axis of the through channel 3122a. In this case, the first end 311a of the blocking member 31a may be ring-shaped and may sleeve an outer side of the spray gun body 1a, and the second end 312a may be a plate-shaped structure and may extend in the flow channel 10a. The through channel 3122a may be a hole penetrating the plate-shaped structure.

Regarding the structure of the blocking member 31a, for example, in other embodiments (not shown in the drawings), the blocking member 31a may be threadedly connected to the spray gun body 1a. Rotating the blocking member 31a may cause the second end 312a to translate in the flow channel 10a, which may also achieve a purpose of completely blocking, partially blocking, or completely opening the flow restricting opening 110a.

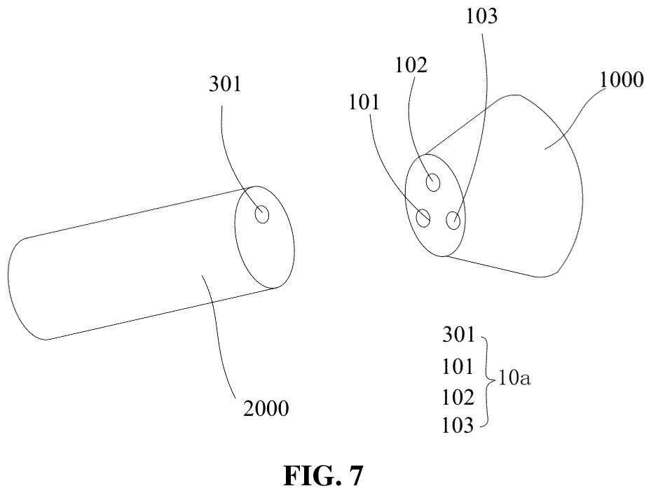

Regarding the spray gun body 1a, in some embodiments, referring to FIGS. 1 and 7, the spray gun body 1a may include a grip member 2000 and a spray head 1000. The grip member 2000 may define an inlet channel 301. The inlet channel 301 may be communicated with an external flow source, such as a water pipe. The spray head 1000 may be rotatably mounted to the grip member 2000. The spray head 1000 may define a first outlet channel 101 and a second outlet channel 102. Rotating the spray head 1000 may drive the first outlet channel 101 and/or the second outlet channel 102 to be communicated with the inlet channel 301. An outlet port of the first outlet channel 101 and an outlet port of the second outlet channel 102 may have two different shapes, achieving different outlet modes. The inlet channel 301, the first outlet channel 101, and the second outlet channel 102 may cooperatively constitute the flow channel 10a. The following description takes an embodiment where the aforementioned first adjustment assembly 20a and second adjustment assembly 30a both act on the inlet channel 301 as an example. Of course, in other embodiments, the spray head 1000 may also define a third outlet channel 103 or more.

At least a part of a surface of the grip member 2000 may be in a shape of a cylinder or other shape which may be convenient for the user to handle and operate. The surface of the grip member 2000 may be covered with an anti-slip material. Thus the user may firmly handle the grip member 2000 in a humid environment or during long time operation. A shape of an overall structure of the spray head 1000 may be cylinder or cone, or a combination of cylinder and cone. The spray head 1000 may rotate relative to the grip member 2000 with an axis of the cylinder or cone as a rotation axis, enabling the user to quickly switch an outlet mode. When the user rotates the spray head 1000, any one of the first outlet channel 101 and the second outlet channel 102 in the spray head 1000 may be enabled to be communicated to the inlet channel 301 of the grip member 2000. Alternatively, the first outlet channel 101 and the second outlet channel 102 may be simultaneously communicated to the inlet channel 301.

In some embodiments, the handheld spray gun may have two outlet modes. Each of the first outlet channel 101 and the second outlet channel 102 corresponds to a respective one of the two outlet modes. The two outlet modes may be switched between each other or used simultaneously by switching the flow of the first outlet channel 101 and the second outlet channel 102. For example, the outlet mode corresponding to the first outlet channel 101 may a concentrated flow mode, which may be suitable for scenarios such as vehicle washing, ground washing, or other stubborn stain removal that require high pressure and a large amount of water; the outlet mode corresponding to the second outlet channel 102 may be a spraying mode, which may be suitable for plant irrigation, cleaning items with easily damaged surfaces, or other scenarios that require a large range and low impact; the two modes may also be enabled simultaneously to meet diverse usage requirements. In other embodiments, the handheld spray gun may further have a third or more outlet modes. In this case, the spray head 1000 may define more than three outlet channels. As shown in FIG. 7, the spray head 1000 may define the third outlet channel 103.

To facilitate the user to apply pressure to the pressing member 4, in some embodiments, referring to FIGS. 1, 2, 4, 5, and 6, the first end 601 of the pressing rod 6 of the handheld spray gun may be rotatably connected to the grip member 2000, specifically in a hinged manner. The second end 602 of the pressing rod 6 may be swingable about the first end 601, and the pressing member 4 may abut against the pressing rod 6. The second end 602 of the pressing rod 6 moving close to the grip member 2000 may drive the pressing member 4 to slide into the inlet channel 301. Conversely, when the second end 602 of the pressing rod 6 swings away from the grip member 2000, the pressing member 4 may correspondingly slide outward. A change in a sliding position of the pressing member 4 may also correspondingly change a flow rate of the inlet channel 301. Furthermore, the pressing member 4 may abut against a portion of the pressing rod 6 which is between the first end 601 and the second end 602, and may be arranged close to the first end 601. The pressing rod 6 may apply pressure to the pressing member 4 based on the lever principle, which may be more labor-saving.

A working principle of the pressing member 4 may be specifically as follows: a blocking member 302 may be arranged in the inlet channel 301. The blocking member 302 may divide the inlet channel 301 into a first connection channel 3011 and a second connection channel 3012. A vertical channel 3023 may be formed in the blocking member 302. An extending direction of the vertical channel 3023 may be perpendicular to an extending direction of the first connection channel 3011 and an extending direction of the second connection channel 3012. The blocking member 302 may be formed with a connection opening 3021. The first connection channel 3011 may be directly communicated to the vertical channel 3023, and the second connection channel 3012 may be communicated to the vertical channel 3023 via the connection opening 3021. The pressing member 4 may include a straight rod 43 and a plug 44. The plug 44 may be arranged in the vertical channel 3023 and may slide along the vertical channel 3023. The straight rod 43 may pass through the connection opening 3021 and may be connected to the plug 44. While sliding outward, the straight rod 43 may drive the plug 44 to block the connection opening 3021. The reset member 7 may act on the plug 44. The second adjustment assembly 30a may act on the first connection channel 3011.

In some embodiments, the pressing member 4 may be arranged in a normally closed manner. Specifically, in an initial state, the resetting member 7 may push against the pressing member 4 via an elastic force of the reset member 7, causing the plug 44 to block the connection opening 3021. When an external force is applied to the second end 602 of the pressing rod 6 by the user, the plug 44 may move away from the connection opening 3021, and thereby the connection opening 3021 may be opened, and the first connecting channel 3011 may be communicated to the second connecting channel 3012. After the external force on the pressing rod 4 is released, the resetting member 7 may drive the plug 44 to slide back to the connection opening 3021 via the elastic force of the resetting member 7, so that the pressing member 4 may return to an initial position, ensuring that the handheld spray gun may be in a closed state when not in use, thus reducing source waste.

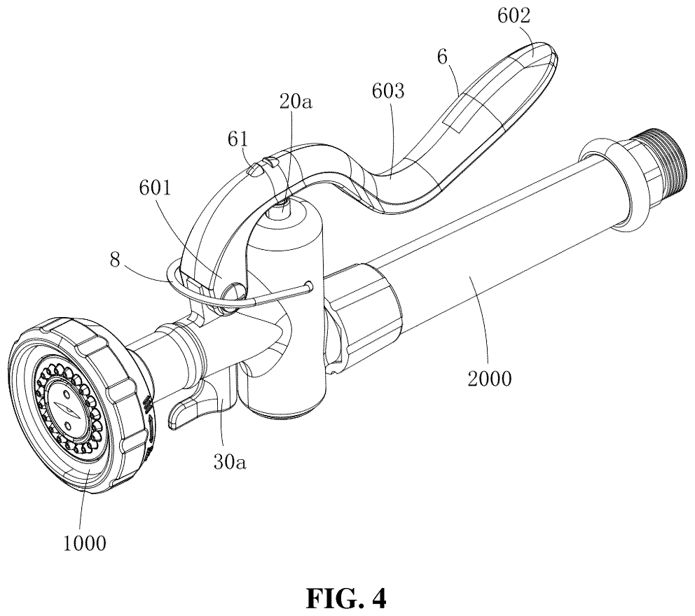

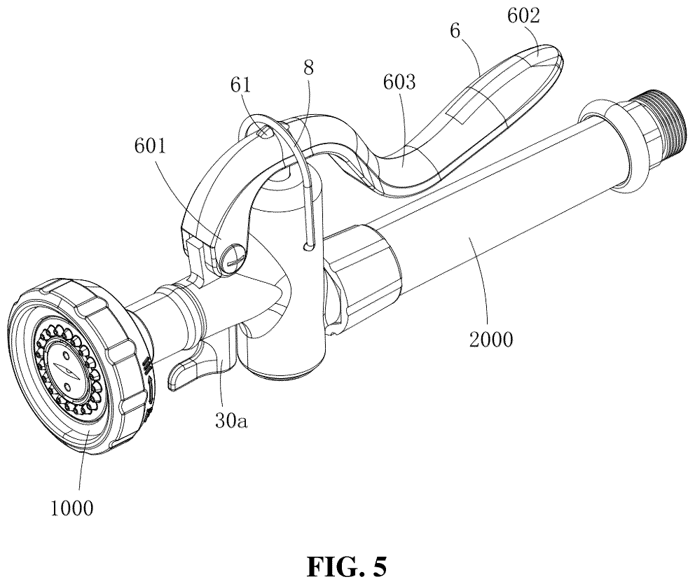

When using the handheld spray gun for a long time, the user needs to press the pressing member 4 for a long time, which may cause discomfort. Therefore, in some embodiments, referring to FIGS. 4 and 5, the handheld spray gun may further include a first engagement ring 8. The first engagement ring 8 may be rotatably arranged on the spray gun body 1a. The pressing rod 6 may be arranged with an engagement protrusion 61. The engagement protrusion 61 may have an abutting face 611 facing the second end 602. When the second end 602 of the pressing rod 6 swings close to the spray gun body 1a, the first engagement ring 8 may swing from the first end 601 of the pressing rod 6 towards the second end 602 of the pressing rod 6 and abut against the abutting face 611 to lock a position of the pressing rod 6.

The arrangement of the first engagement ring 8 may be used to lock the pressing rod 6 at a specific angle, that is, to keep the pressing member 4 fixed at a certain position, thereby facilitating the user to continuously use the flow outlet function for a long time in specific scenarios without needing to press the pressing member 4 with the thumb for a long time. The first engagement ring 8 may be arranged to surround an outer side of the engagement protrusion 61 of the pressing rod 6. The first engagement ring 8 may be rotatably mounted on the grip member 2000, and a rotation center of the first engagement ring 8 may be located between a hinged position of the pressing rod 6 and the grip member 2000 and the abutting face 611. In this way, the first engagement ring 8 may have a locked state and a released state.

The locked state may refer to a state of the first engagement ring 8 as shown in FIG. 5. Specifically, when the user presses the second end 602 of the pressing rod 6, causing the second end 602 to swing closer to the grip member 2000 and drive the pressing member 4 to slide for adjusting an opening degree of the inlet channel 301, the first engagement ring 8 may swing from the first end 601 of the pressing rod 6 to the abutting face 611. At this time, when the user stops pressing the pressing rod 6, the pressing rod 6 may attempt to reset under an action of the resetting member 7, and the first engagement ring 8 may abut against the abutting face 611 of the engagement protrusion 61, thereby locking the pressing member 4 at a current position. In this way, the opening degree of the inlet channel 301 may be kept constant, and the handheld spray gun may provide a continuous and stable flow.

The released state may refer to a state of the first engagement ring 8 as shown in FIG. 4. Specifically, when the user presses the second end 602 of the pressing rod 6 once more, the first engagement ring 8 may disengage from the abutting face 611 and swing towards the first end 601 of the pressing rod 6 until the first engagement ring 8 completely passes over the first end 601 of the pressing rod 6. At this time, the first engagement ring 8 may release a limit on the pressing rod 6, and the pressing rod 6 may be reset to an initial position driven by the resetting member 7. Meanwhile, the pressing member 4 may slide accordingly, so that the inlet channel 301 may be closed or the opening degree of the inlet channel 301 may be reduced, thereby terminating or adjusting the flow.

The arrangement of the first engagement ring 8 may facilitate an application of the handheld spray gun in scenarios where the user's hands may be freed, such as washing vegetables in the kitchen. Washing vegetables usually requires the user to operate with both hands. At this time, it may be necessary to use the first engagement ring 8 to fix the position of the pressing rod 6, so that the pressing member 4 may continuously open the inlet channel 301. However, at this time, the user may not rely on the pressing member 4 to adjust the outflow rate. For usage scenarios like washing vegetables, a large water flow rate may be not needed. Therefore, the arrangement of the second adjustment assembly 30a may facilitate the user to change the outflow rate through the second adjustment assembly 30a, so as to save resources in special usage scenarios.

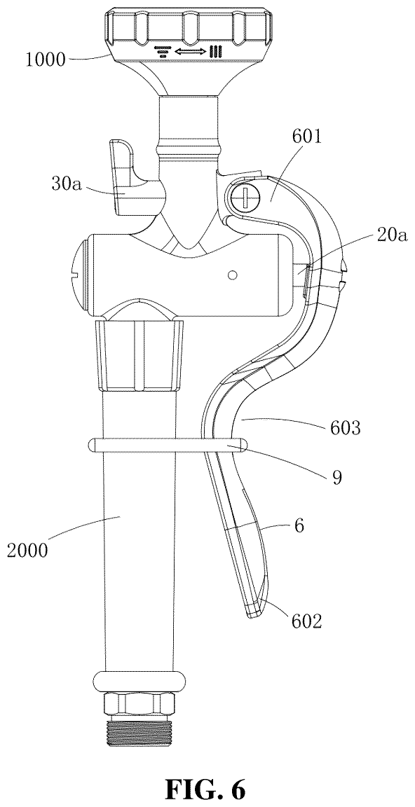

For a same purpose as the first engagement ring 8, in some embodiments, referring to FIG. 6, the handheld spray gun may further include a second engagement ring 9, which may be used instead of the first engagement ring 8. Specifically, the pressing rod 6 may be arranged with a recess portion 603 between the first end 601 and the second end 602. The second engagement ring 9 may be arranged independent from the grip member 2000. When the second end 602 of the pressing rod 6 swings close to the grip member 2000, the second engagement ring 9 may pass over the second end 602 and move towards the first end 601, so that the second engagement ring 9 may sleeve the recess portion 603 and the grip member 2000 to lock the position of the pressing rod 6, as shown in FIG. 6.

Regarding the above solution for achieving different outlet modes, in some embodiments, referring to FIGS. 1, 2, 17, and 20, specifically, the spray gun body 1a may further include a connection seat 5 mounted to the grip member 2000. The inlet channel 301 may penetrate through the connection seat 5. The spray head 1000 may include a housing 1 and a flow dividing assembly 2. The housing 1 may be rotatably mounted to the connection seat 5. The housing 1 may define a mounting cavity 11. The flow dividing assembly 2 may be mounted in the mounting cavity 11. The flow dividing assembly 2 may divide the mounting cavity 11 to form the first outlet channel 101 and the second outlet channel 102. That is, the first outlet channel 101 and the second outlet channel 102 may be actually formed in the flow dividing assembly 2. Changing a relative positional relationship between the flow dividing assembly 2 and the connection seat 5 may achieve a switching of an outlet mode.

Specifically, when the spray head 1000 is rotated, the flow dividing assembly 2 may rotate synchronously with the housing 1, and the flow dividing assembly 2 and the connection seat 5 may undergo a relative rotation, thereby switching a connection relationship between the outlet channels (including the first outlet channel 101 and the second outlet channel 102) and the inlet channel 301. In some embodiments, the flow dividing assembly 2 and the connection seat 5 may be closely attached to each other to prevent the first outlet channel 101 and the second outlet channel 102 from being communicated with each other at an area between the flow dividing assembly 2 and the connection seat 5. If there is a gap between the flow dividing assembly 2 and the connection seat 5, a flow in the inlet channel 301 may flow simultaneously to the first outlet channel 101 and the second outlet channel 102 from this gap. In other words, the first outlet channel 101 and the second outlet channel 102 may be communicated with each other via this gap. Thus, when the spray head 1000 is rotated, the communication relationship between the inlet channel 301 and the outlet channels cannot be switched. Therefore, the flow dividing assembly 2 and the connection seat 5 should be closely attached to each other to avoid the flow entering the area between the flow dividing assembly 2 and the connection seat 5, and ensure that the flow may selectively enter one of the first outlet channel 101 and the second outlet channel 102 according to the user's requirements, thereby realizing accurate switching of the outlet mode. For example, when the user chooses to only have the first outlet channel 101 communicated to the inlet channel 301, the flow in the inlet channel 301 may be prevented from flowing through the area between the flow dividing assembly 2 and the connection seat 5 to the second outlet channel 102, thus avoiding a disordered outlet mode.

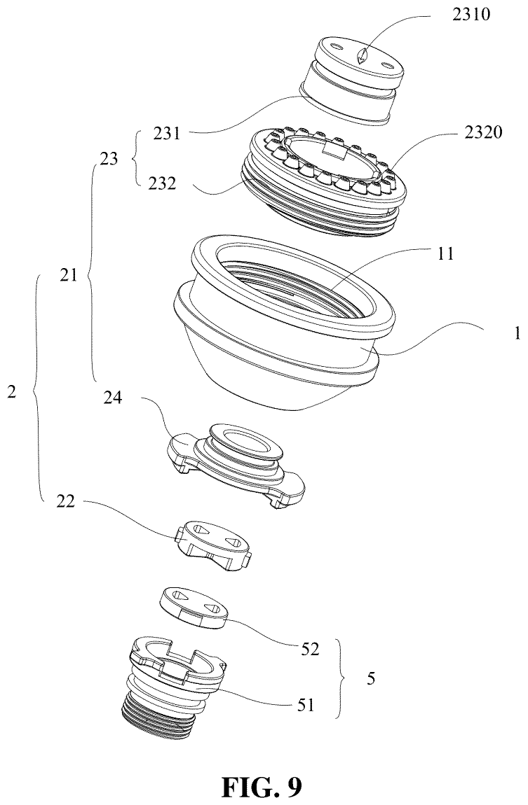

In some embodiments, referring to FIG. 9, the connection seat 5 includes a first seat 51 and a first contact member 52 mounted to the first seat 51. The inlet channel 301 may penetrate through the first seat 51 and the first contact member 52. The flow dividing assembly 2 may include a second seat 21 and a second contact member 22 mounted to the second seat 21. Each of the first outlet channel 101 and the second outlet channel 102 may penetrate through the second seat 21 and the second contact member 22. The first contact member 52 and the second contact member 22 may be closely attached to each other so as to prevent the first outlet channel 101 and the second outlet channel 102 from being communicated with each other at an area between the first contact member 52 and the second contact member 22, thereby avoiding the aforementioned problem of the disordered outlet mode.

The first contact member 52 may be fixedly mounted at an upper end of the first seat 51. The inlet channel 301 may allow the flow to only pass through the first contact member 52 into the mounting cavity 11, and moreover, an upper face of the first contact member 52 may be in contact with the second contact member 22. The second contact member 22 may be fixedly mounted to a side of the second seat 21 facing the connection seat 5. Each of the first outlet channel 101 and the second outlet channel 102 may be formed though the second contact member 22 and may be communicated to the inlet channel 301 only from the second contact member 22. Moreover, a lower face of the second contact member 22 may be in contact with the first contact member 52. In this embodiment, to a certain degree, the first contact member 52 may be independent from the connection seat 5, and the second contact member 22 may be independent from the flow dividing assembly 2. Each of the first contact member 52 and the second contact member 22 may be made of a wear resistant material, such as a ceramic material. In this way, a problem that a face of the first contact member 52 in contact with the second contact member 22 and a face of the second contact member 22 in contact with the first contact member 52 are prone to wear and tear during long term and high frequency use may be solved. Other parts of the connection seat 5 and the flow dividing assembly 2, such as the first seat 51 and the second seat 21, may be made of materials such as metal and plastic to meet respective strength or toughness requirements.

In some embodiments, in order to ensure a smooth relative rotation between the first contact member 52 and the second contact member 22, each of the face of the first contact member 52 in contact with the second contact member 22 and the face of the second contact member 22 in contact with the first contact member 52 may be smooth. Processing methods such as polishing may be used to reduce pits or processing patterns on the faces and reduce friction coefficients of the faces, so as to enable the first contact member 52 and the second contact member 22 to rotate relative to each other as smoothly as possible.

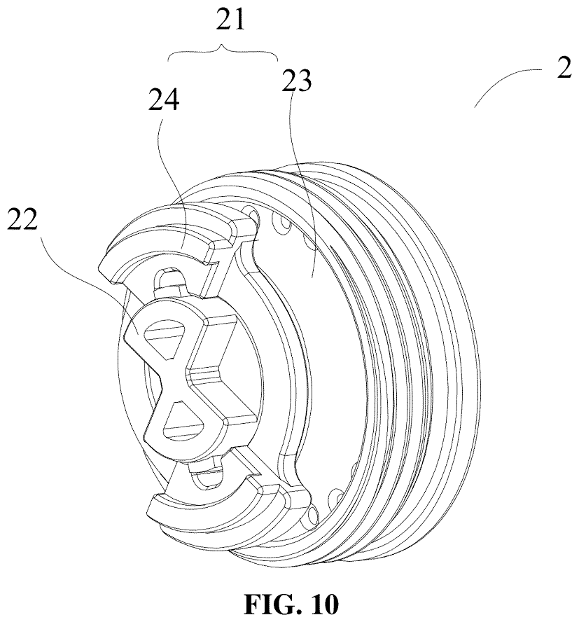

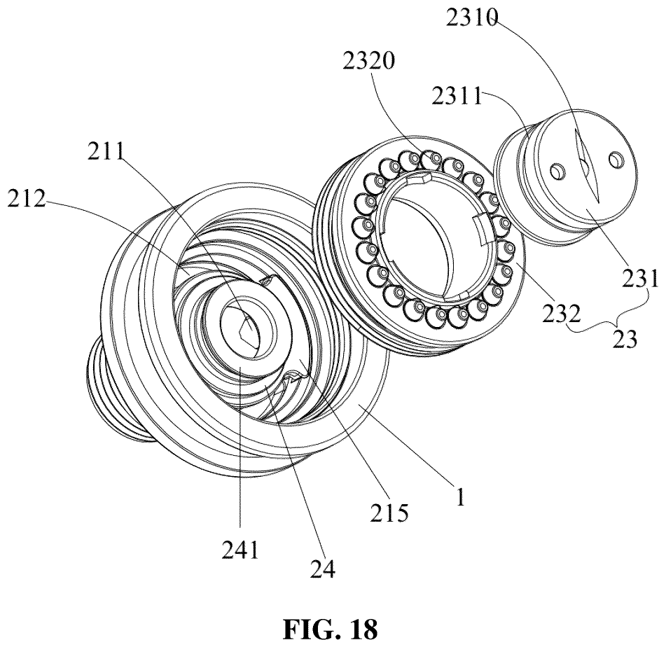

In some embodiments, as illustrated in FIGS. 10-12, the second seat 21 may define a first outlet branch 211 and a second outlet branch 212. The second contact member 22 may define at least one third outlet branch 221 and at least one fourth outlet branch 222. The first outlet branch 211 and the at least one third outlet branch 221 may be communicated to each other to form the first outlet channel 101, and the second outlet branch 212 and the at least one fourth outlet branch 222 may be communicated to each other to form the second outlet channel 102. Referring to FIG. 18, the first outlet branch 211 may be formed in the middle of the second seat 21, and the second outlet branch 212 may be cooperatively formed by the second seat 21 and an inner wall of the mounting cavity 11.

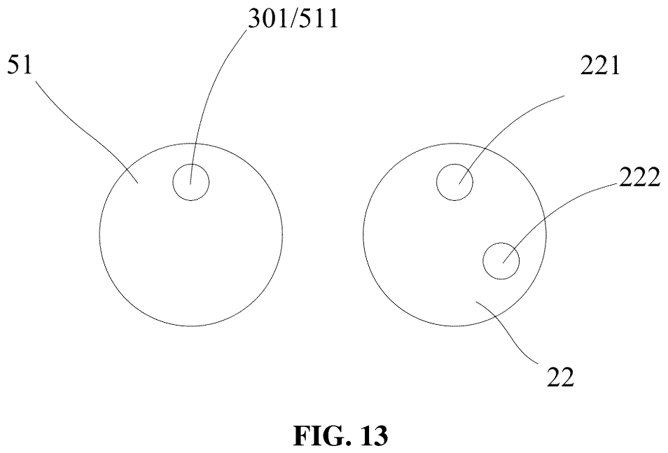

In some embodiments, the at least one third outlet branch 221 and the at least one fourth outlet branch 222 may be switched to allow the flow to pass via the second contact member 22. Then neither the at least one third outlet branch 221 nor the at least one fourth outlet branch 222 may be communicated to a rotation center of the second contact member 22, while the at least one third outlet branch 221 and the at least one fourth outlet branch 222 should be formed eccentrically, as shown in FIG. 13.

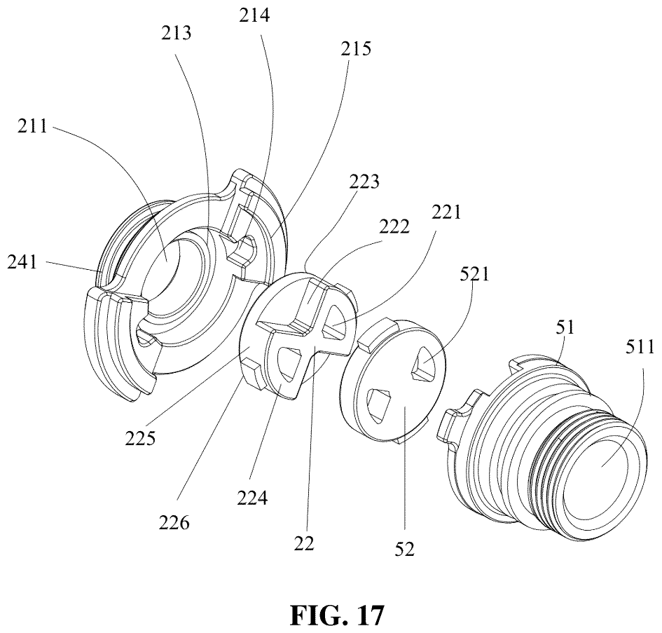

As illustrated in FIG. 17, the second contact member 22 may have a top face 223, a bottom face 224, and a side face 225. The at least one third outlet branch 221 may penetrate through the second contact member 22 from the bottom face 224 to the top face 223, and the at least one fourth outlet branch 222 may penetrate through the second contact member 22 from the bottom face 224 to the side face 225.

Specifically, the at least one third outlet branch 221 and the at least one fourth outlet branch 222 may be hole-like structures formed in the second contact member 22, or be notch structures formed in the second contact member 22.

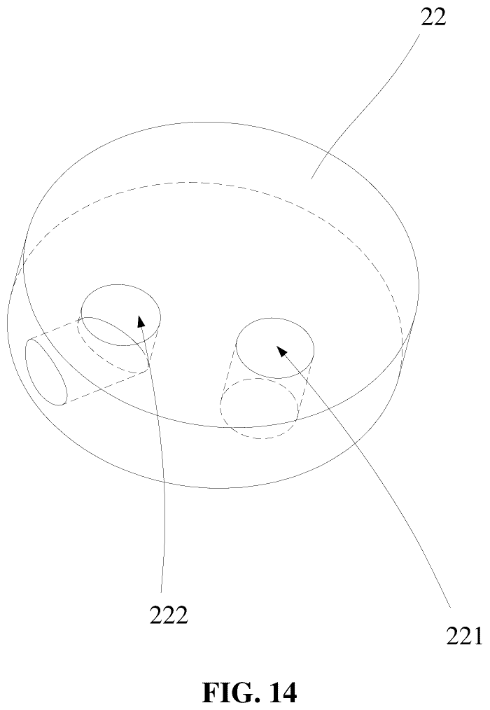

For example, in some embodiments, as shown in FIG. 14, the second contact member 22 may be mounted in the first outlet branch 211. The number of the at least one third outlet branch 221 may be one, and the number of the at least one fourth outlet branch 222 may be also one. The third outlet branch 221 may be a vertical hole-like channel penetrating through the second contact member 22 from the bottom face 224 to the top face 223. An upper end of the third outlet branch 221 may be communicated to the first outlet branch 211, and a lower end of the third outlet branch 221 may be communicated to the inlet channel 301. The fourth outlet branch 222 may be an “L” shaped hole-like channel penetrating through the second contact member 22 from the bottom face 224 to the side face 225, and a side end of the fourth outlet branch 222 may be communicated to the second outlet branch 212, and a lower end of the fourth outlet branch 222 may be communicated to the inlet channel 301.

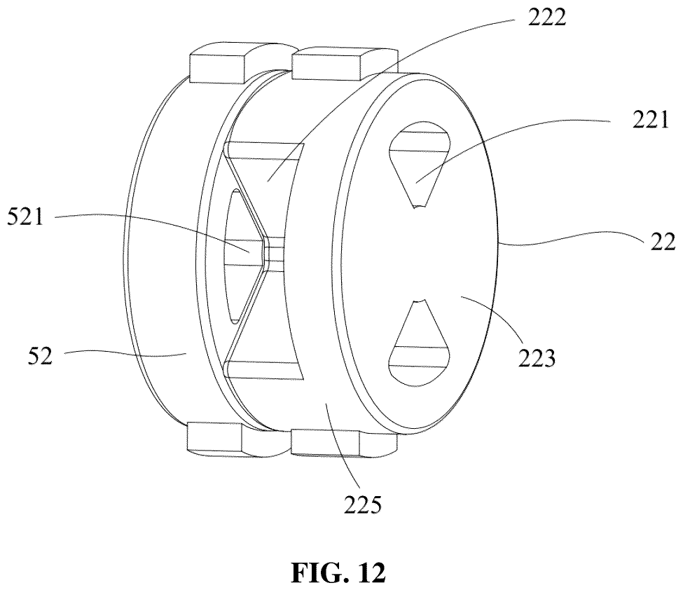

For example, in another embodiment shown in FIG. 12, the second contact member 22 may be mounted in the first outlet branch 211. Each of the at least one third outlet branch 221 may be a vertical hole-like channel penetrating through the second contact member 22 from the bottom face 224 to the top face 223, and an upper end of the each of the at least one third outlet branch 221 may be communicated to the first outlet branch 211, and a lower end of the each of the at least one third outlet branch 221 may be communicated to the inlet channel 301. The second contact member 22 may define a notch from the bottom face 224 to the side face 225, and the notch may form the at least one fourth outlet branch 222.

Therefore, as long as the first contact member 52 and the second contact member 22 form a flow passing structure after being mounted in contact with each other, and both the flow passing structure independently formed by the second contact member 22 and the flow passing structure cooperatively formed by the first contact member 52 and the second contact member 22 may be considered as the at least one third outlet branch 221 or the at least one fourth outlet branch 222 formed in the second contact member 22. The second outlet branch 212 may be an annular flow channel cooperatively defined by the second seat 21 and the inner wall of the mounting cavity 11. In this case, the second contact member 22 may be mounted in the first outlet branch 211, and only a special design for the second outlet branch 212 may be required. To facilitate manufacture of the second contact member 22, each of the at least one fourth outlet branch 222 may be designed as a notch manner. When it is required to switch to the second outlet channel 102 for flow outlet, the inlet channel 301 may be enabled to be communicated to the notch. In this way, a direction of the flow in a straight flow direction may be changed after passing through the notch, so as to guide the flow to the annular second outlet branch 212.

In some embodiments, as the at least one third outlet branch 221 and the at least one fourth outlet branch 222 are required to be designed eccentrically, and a single aperture has a relatively large limitation on the flow rate. Therefore, in some embodiments, with reference to FIG. 17, the first seat 51 may define only one first inlet branch 511, and the first contact member 52 may define at least two second inlet branches 521. Each of at least two second inlet branches 521 may be communicated to the first inlet branch 511. Each of the number of the at least one third outlet branch 221 and the number of the at least one fourth outlet branch 222 may be consistent with the number of the at least two second inlet branches 521. Each of the at least one third outlet branch 221 and the at least one fourth outlet branch 222 may be capable of being communicated to a respective one of the at least two second inlet branches 521.

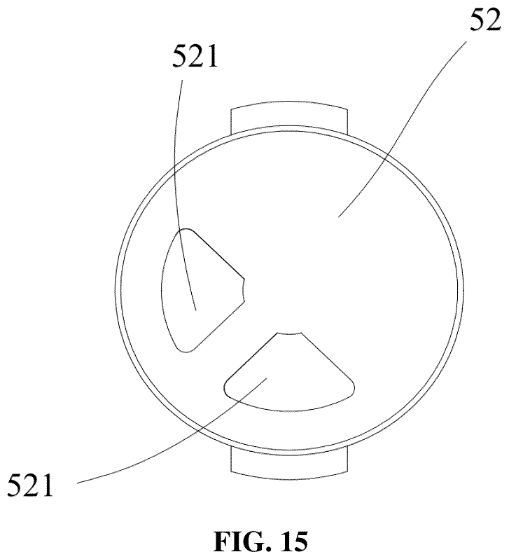

For example, as shown in FIG. 15, the first contact member 52 may define two second inlet branches 521, and the two second inlet branches 521 may be circumferentially distributed within a certain angle range around a center of the first contact member 52.

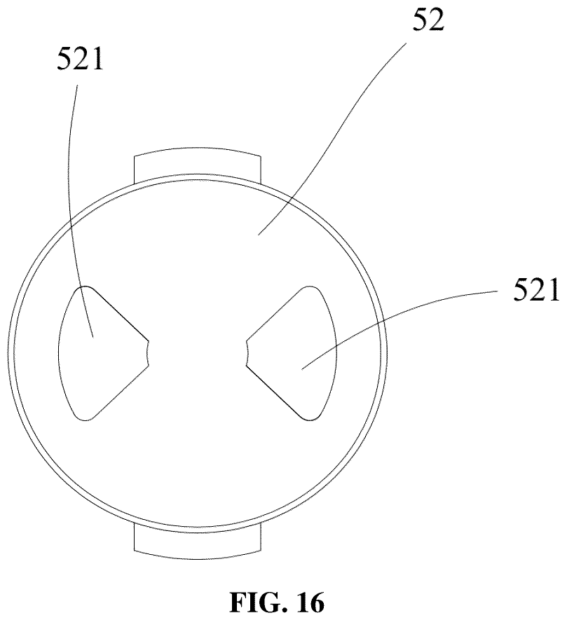

For example, referring to FIGS. 16-17, the first contact member 52 may define two second inlet branches 521, and the two second inlet branches 521 may be symmetrically arranged about the center of the first contact member 52. The second contact member 22 may define two third outlet branches 221 and two fourth outlet branches 222. The two third outlet branches 221 may be symmetrically arranged about the center of the second contact member 22, and the two fourth outlet branches 222 may be symmetrically arranged about the center of the second contact member 22. In this way, the first contact member 52 and the second contact member 22 may be utilized to a greater extent and the flow rate may be increased.

The first seat 51 may define a first inlet branch 511 penetrating through an overall structure of the first seat 51. The first inlet branch 511 may be used to introduce a flow from the handle. Each of the at least two second inlet branches 521 formed in the first contact member 52 may be communicated to the first inlet branch 511, so as to realize a further division of the flow. An increase in the number of the at least two second inlet branches 521 may increase an inlet volume of the flow, and moreover, improve uniformity of the flow. In order to adapt to an inlet mode of the first contact member 52 and keep a uniform flow state, each of the number of the at least one third outlet branch 221 and the number of the at least one fourth outlet branch 222 may be consistent with the number of the at least two second inlet branch 521.

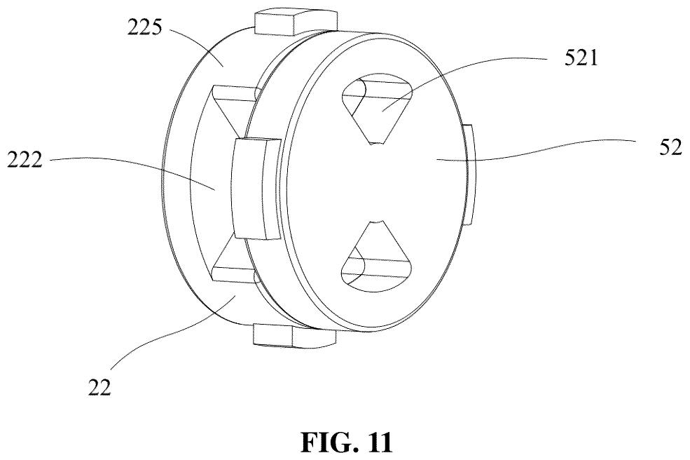

In some embodiments, referring to FIGS. 11-12, each of the number of the at least two second inlet branches 521, the number of the at least one third outlet branch 221, and the number of the at least one fourth outlet branch 222 may be two. The two second inlet branches 521 may be centrosymmetrically distributed, the two third outlet branches 221 may be centrosymmetrically distributed, and the two fourth outlet branches 222 may be centrosymmetrically distributed. The symmetrically arrangement may reduce flow pressure imbalance that may be generated by a single branch, and may improve stability and uniformity of flow outlet.

In some embodiments, as illustrated to FIG. 17, the second seat 21 may define a receiving groove 213, and the second contact member 22 may be received in the receiving groove 213. The second seat 21 may further define a first positioning groove 214, the second contact member 22 may be arranged with a first positioning protrusion 226, and the first positioning protrusion 226 may be arranged in the first positioning groove 214, so as to prevent the second contact member 22 from rotating relative to the second seat 21.

In order to fix the second contact member 22 to the second seat 21, the receiving groove 213 of the second seat 21 may match an outer contour of the second contact member 22, and the receiving groove 213 may provide a mounting position for the second contact member 22. In order to enable the second contact member 22 to rotate integrally with the second seat 21, the first positioning protrusion 226 may be arranged in the first positioning groove 214, so that the second contact member 22 may be circumferentially fixedly mounted to the second seat 21. In some embodiments, there may be two first positioning protrusions 226 and two first positioning grooves 214 correspondingly.

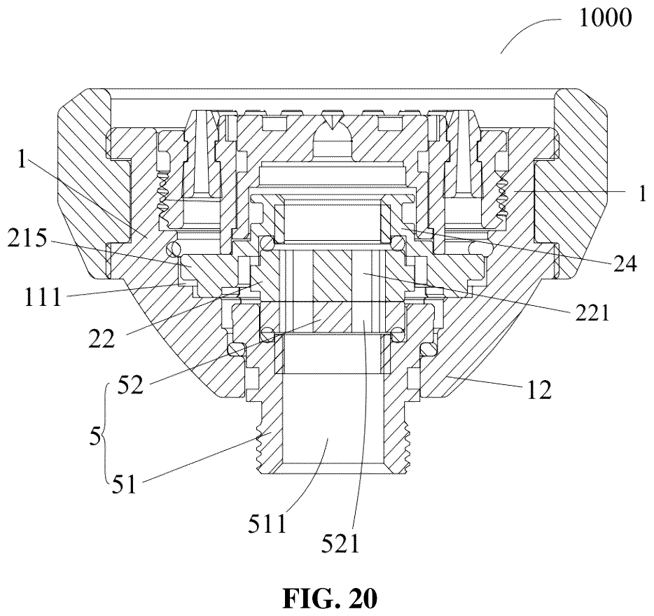

In some embodiments, referring to FIGS. 17 and 20, the second seat 21 may be arranged with a second positioning protrusion 215, and the housing 1 may define a second positioning groove 111 in the mounting cavity 11. The second positioning groove 111 may extend vertically, and the second positioning protrusion 215 may be inserted in the second positioning groove 111 along an extending direction of the second positioning groove 111.

The second positioning groove 111 may extend vertically, providing a top-down guidance, which may allow the second positioning protrusion 215 to be vertically inserted in the second positioning groove 111. Besides guiding and positioning, the engagement design between the second positioning protrusion 215 and the second positioning groove 111 may further prevent the second seat 21 from rotating. Since a shape of the second positioning protrusion 215 may match a shape of the second positioning groove 111, the second positioning protrusion 215 may be restricted in a circumferential direction after being engaged in the second positioning groove 111, thus preventing the second seat 21 from rotating relative to the housing 1 in the mounting cavity 111.

In some embodiments, as shown in FIG. 18, the second seat 21 includes an outlet member 23 and a mounting member 24. The mounting member 24 may be mounted in the mounting cavity 11, the second contact member 22 may be mounted to the mounting member 24, and each of the first outlet branch 211 and the second outlet branch 212 may penetrate through the mounting member 24. The outlet member 23 may define a first outlet hole 2310 and at least one second outlet hole 2320. The first outlet hole 2310 may communicate the first outlet branch 211 to the outside, and the at least one second outlet hole 2320 may communicate the second outlet branch 212 to the outside. The first outlet branch 211, the at least one third outlet branch 221, and the first outlet hole 2310 cooperatively form the first outlet channel 101, and the second outlet branch 212, the at least one fourth outlet branch 222, and the at least one second outlet hole 2320 cooperatively form the second outlet channel 102. The outlet member 23 and the mounting member 24 may be detachably connected with each other, and the outlet member 23 may be detachably connected with the housing 1.

The second seat 21 may include two parts, namely the mounting member 24 and the outlet member 23, which may be convenient for maintenance and replacement during use. The outlet member 23 and the second contact member 22 may be both mounted to the mounting member 24 to cooperatively form the flow dividing assembly 2. The second positioning protrusion 215 may be arranged on the mounting member 24 to connect the flow dividing assembly 2 to the housing 1. In this way, the flow dividing assembly 2 and the housing 1 may rotate synchronously.

When the outlet member 23 is damaged, the outlet member 23 may be individually disassembled for cleaning or replacement without replacing the entire spray head 1000, which may simplify maintenance and save costs.

In some embodiments, a notch may be formed in an inner peripheral side of the mounting member 24. The inner peripheral side of the mounting member 24 corresponding to the notch and the inner wall of the mounting cavity 11 may cooperatively define the second outlet branch 212. The notch in the second contact member 22 and the notch in the mounting member 24 may be communicated to each other and cooperatively form the second outlet channel 102.

In some embodiments, referring to FIG. 18, the mounting member 24 may be arranged with a nest protrusion 241, and the first outlet branch 211 may penetrate through the nest protrusion 241. The outlet member 23 may be arranged with a sleeve 2311. The first outlet hole 2310 may be communicated to an interior of the sleeve 2311. The sleeve 2311 may sleeve a periphery of the nest protrusion 241. The second outlet branch 212 may be formed to surround the sleeve 2311. Specifically, the mounting member 24 and the outlet member 23 may be connected with each other by the sleeve 2311 sleeving the nest protrusion 241. In order to prevent flow from leaking into the second outlet branch 212 when passing through a connection area between the nest protrusion 241 and the sleeve 2311, the nest protrusion 241 and the sleeve 2311 may be connected with each other in an interference fit, or a sealing component such as a sealing ring may be arranged at a contact position between the nest protrusion 241 and the sleeve 2311.

Moreover, referring to FIG. 18, the outlet member 23 may include a first outlet head 231 and a second outlet head 232. The first outlet hole 2310 may be formed in the first outlet head 231, and the first outlet head 231 may be arranged with the sleeve 2311. The second outlet head 232 may sleeve a periphery of the first outlet head 231. The at least one second outlet hole 2320 may be formed in the second outlet head 232. The second outlet head 232 may be threadedly connected to the housing 1, thereby realizing a detachable connection between the second outlet head 232 and the housing 1. There may be a plurality of second outlet holes 2320, and the plurality of second outlet holes 2320 may be circumferentially distributed to surround the first outlet head 231.

In some embodiments, the second outlet head 232 may detachably sleeve the periphery of the first outlet head 231 and connected with the first outlet head 231, thereby forming the outlet member 23. The second outlet head 232 may be threadedly connected to the housing 1. That is to say, after the first outlet head 231 and the second outlet head 232 cooperatively form the outlet member 23, the outlet member 23 may be further detachably connected to the housing 1 by threads, and each of the first outlet head 231 and the second outlet head 232 may be independently removed from the second seat 21.

The handheld spray gun may be equipped with a plurality of different first outlet heads 231 and second outlet heads 232. Each of the plurality of first outlet heads 231 or second outlet heads 232 may have the first outlet hole 2310 or second outlet hole 2320 with different shapes or sizes. This may allow the user to replace or make various combinations of the first outlet head 231 and the second outlet head 232 as required, thereby providing more diverse usage modes.

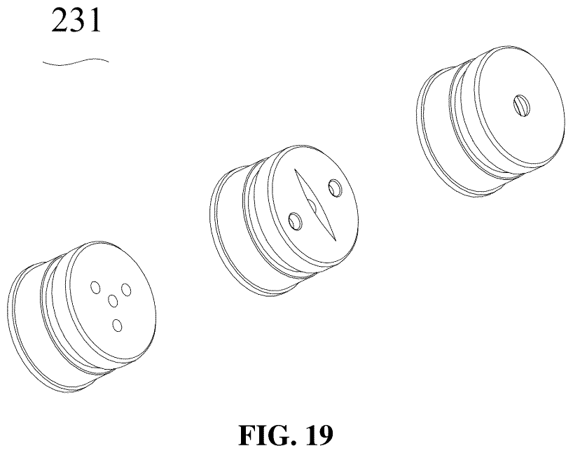

For example, with reference to FIG. 19, the first outlet head 231 may be arranged to provide a straight flow outlet mode. The first outlet hole 2310 may be in a form of a single hole or multiple holes. The first outlet hole 2310 in the form of single hole may be a circular hole to provide a direct shooting flow or a long strip shaped hole to provide a fan shaped flow. The first outlet hole 2310 in the form of multiple holes may be arranged in a flat face to provide a more concentrated direct shooting flow or in a convex face to provide a diffused flow.

The second outlet head 232 may allow flow to spray out. The second outlet head 232 may have a plurality of second outlet holes 2320, and the plurality of second outlet holes 2320 may be circumferentially distributed to surround the first outlet head 231. In this way, a uniform spraying effect may be achieved and the sprayed water may cover a larger area. An extending direction of at least a part of the plurality of second outlet holes 2320 may be slightly outwardly inclined, so that the sprayed flow may be dispersed and a coverage area of the sprayed flow may be increased.

In some embodiments, the handheld spray gun may adopt various pulse modes and driving mechanisms to achieve more diverse outflow effects and meet the requirements of specific scenarios. For example, the handheld spray gun may provide a continuous straight shooting outflow with a stable flow, which may be suitable for efficient cleaning of stubborn stains or target-concentrated rinsing tasks. The handheld spray gun may be equipped with a pulse control device, so that the outflow may be in a regular intermittent pattern, which may be suitable for cleaning more sensitive surfaces or scenarios where water consumption needs to be reduced. By adjusting a pulse frequency, an intermittent rhythm of the outflow may be changed from rapid dot shooting to slow intermittent, flexibly adapting to different requirements. Moreover, the handheld spray gun may be combined with a driving mechanism, with the first outlet head 231 rotatably arranged, so that the outflow may form a spiral trajectory during a spraying process.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. A handheld spray gun, comprising:
a spray gun body, defining a flow channel;
an adjustment mechanism, wherein at least a portion of the adjustment mechanism is movably arranged in the flow channel, and the adjustment mechanism is configured to block, partially block, or open the flow channel; and
a pressing rod, wherein a first end of the pressing rod is movably connected to the spray gun body, and a second end of the pressing rod is swingable about the first end, enabling the pressing rod to drive at least a portion of the adjustment mechanism to move in the flow channel.

2. The handheld spray gun according to claim 1, wherein the adjustment mechanism comprises:
a first adjustment assembly, wherein at least a portion of the first adjustment assembly is slidably arranged in the flow channel, and the pressing rod is configured to drive the first adjustment assembly to block or open the flow channel; and
a second adjustment assembly, wherein at least a portion of the second adjustment assembly is movably arranged in the flow channel and is configured to adjust a flow rate of the flow channel.

3. The handheld spray gun according to claim 2, wherein the spray gun body is arranged with a flow restricting portion, and the flow restricting portion is arranged in the flow channel; the flow restricting portion defines a flow restricting opening, and a section of the flow channel on one side of the flow restricting portion and another section of the flow channel on the other side of the flow restricting portion are communicated with each other via the flow restricting opening;
the second adjustment assembly comprises a blocking member, the blocking member is movably mounted to the spray gun body, a first end of the blocking member is arranged outside the spray gun body, and a second end of the blocking member is arranged in the flow channel;
driving the first end of the blocking member to move correspondingly enables the second end of the blocking member to partially block or open the flow restricting opening, and the flow rate of the flow channel is controlled according to a blocking degree of the flow restricting opening.

4. The handheld spray gun according to claim 3, wherein the blocking member is rotatably mounted to the spray gun body, the second end of the blocking member comprises a blocking part, the blocking part defines a through channel penetrating through the blocking part, and the through channel is communicable with the flow restricting opening;
rotating the blocking member enables the through channel to be communicated with the flow restricting opening to open the flow restricting opening, or enables the blocking part to partially block the flow restricting opening.

5. The handheld spray gun according to claim 4, wherein a rotation axis of the blocking member is perpendicular to an axis of the flow restricting opening, and an axis of the through channel is perpendicular to the rotation axis of the blocking member.

6. The handheld spray gun according to claim 4, wherein the blocking member defines a limiting notch, the blocking member comprises a first abutting end arranged on one side of the limiting notch and a second abutting end arranged on the other side of the limiting notch, and the second adjustment assembly further comprises:
a center rod, penetrating through the blocking member and fixed to the spray gun body, wherein the blocking member is rotatable about the center rod; and
a limiting rod, mounted in the flow channel and inserted in the limiting notch;
wherein rotating the blocking member enables the limiting rod to abut against the first abutting end or against the second abutting end.

7. The handheld spray gun according to claim 2, wherein the first adjustment assembly comprises:
a pressing member, slidably mounted to the spray gun body and inserted in the flow channel, wherein a sliding of the pressing member enables the flow channel to be opened or blocked; and
a reset member, arranged in the flow channel, connected to the pressing member, and configured to drive the pressing member to slide outward from the spray gun body.

8. The handheld spray gun according to claim 7, wherein a sliding direction of the pressing member is perpendicular to an extending direction of the flow channel.

9. The handheld spray gun according to claim 7, wherein the pressing member abuts against a portion of the pressing rod which is arranged between the first end of the pressing rod and the second end of the pressing rod, and is arranged close to the first end of the pressing rod, and the pressing rod is configured to drive the pressing member to slide in the flow channel when the pressing rod is swinging.

10. The handheld spray gun according to claim 1, further comprising an engagement ring, wherein the engagement ring is rotatably arranged on the spray gun body, the pressing rod is arranged with an engagement protrusion, and the engagement protrusion has an abutting face facing the second end of the pressing rod;
when the second end of the pressing rod swings towards the spray gun body, the engagement ring is enabled to swing from the first end of the pressing rod towards the second end of the pressing rod and abut against the abutting face to lock a position of the pressing rod.

11. The handheld spray gun according to claim 2, wherein the spray gun body comprises a grip member and a spray head, the grip member defines an inlet channel, the spray head is rotatably mounted to the grip member, and the spray head defines a first outlet channel and a second outlet channel;
rotating the spray head enables one of the first outlet channel and the second outlet channel to be communicated with the inlet channel;
wherein the inlet channel, the first outlet channel, and the second outlet channel cooperatively form the flow channel, and each of the first adjustment assembly and the second adjustment assembly is configured to act on the inlet channel.

12. The handheld spray gun according to claim 11, wherein the spray gun body further comprises a connection seat mounted to the spray head, and the inlet channel penetrates through the connection seat;
the spray head comprises a housing and a flow dividing assembly, the housing is rotatably mounted to the connection seat, the housing defines a mounting cavity, the flow dividing assembly is mounted in the mounting cavity, the mounting cavity is divided by the flow dividing assembly to form the first outlet channel and the second outlet channel, and the flow dividing assembly and the connection seat are closely attached to each other to prevent the first outlet channel and the second outlet channel from being communicated to each other at an area between the flow dividing assembly and the connection seat.

13. The handheld spray gun according to claim 12, wherein the connection seat comprises a first seat and a first contact member mounted to the first seat, and the inlet channel penetrates through the first seat and the first contact member;
the flow dividing assembly comprises a second seat and a second contact member mounted to the second seat, each of the first outlet channel and the second outlet channel penetrates through the second seat and the second contact member, the first contact member and the second contact member are closely attached to each other and are configured to prevent the first outlet channel and the second outlet channel from being communicated with each other at an area between the first contact member and the second contact member, and each of the first contact member and the second contact member is made of a wear resistant material.

14. The handheld spray gun as claimed in claim 13, wherein the second seat defines a first outlet branch and a second outlet branch, the second contact member defines at least one third outlet branch and at least one fourth outlet branch;
the second contact member is mounted in the first outlet branch, the first outlet branch and the at least one third outlet branch are communicated to each other and cooperatively form the first outlet channel, and the second outlet branch and the at least one fourth outlet branch are communicated to each other and cooperatively form the second outlet channel.
